(19) United States
(12) Patent Application Publication
(10) Pub. No.: US 2004/0064478 A1
(43) Pub. Date: Apr. 1, 2004

(54) Method for composing and transmitting and method for receiving and looking-up an eletronic message

(76) Inventor: Alberto Maria Canesi, Monza (IT)

Correspondence Address: YOUNG & THOMPSON, 745 SOUTH 23RD STREET 2ND FLOOR, ARLINGTON, VA, 22202

(21) Appl. No.: 10/467,635

(22) PCT Filed: Feb. 5, 2002
(86) PCT No.: PCT/IT02/00068

(30) Foreign Application Priority Data
Feb. 9, 2001 (IT) RM2001A000067

(51) Int. Cl. G06F 7/00

(52) U.S. Cl. 707/104.1

(57) ABSTRACT

A method for composing and transmitting, and method for receiving and looking-up an electronic message which enable an operator to simply interact with a computer provided with a visualiser or a display, so as to enable electronic documents visualizable by informatic programs not included in the computer to be visualized, thereby allowing a noticeable reduction of any infomatic virus diffusion. Instruments needed to perform such methods and the apparatus by which the methods are performed are also disclosed.

This invention relates to a method for composing and transmitting as well as to a method for receiving and looking-up an electronic message which enable an operator to simply interact with a computer provided with a visualiser or a display, so as to enable electronic documents visualizable by means of informatic programs not included in said computer to be visualised, thereby allowing a noticeable reduction of any informatic virus diffusion.

This invention also relates to the instruments needed to perform such methods and to the apparatus by which the methods are performed.

In the following description, the visualizer will be also designated with term display.

As it is known, one of the most largely used and continuously increasing applications, for instance in the Internet network, is the electronic mail or e-mail. As a general rule, an e-mail application requires the composition of an electronic message by a sender user computer or client. When an electronic message is to be transmitted, the sender client is adapted to be connected to a correspondent sender serving computer or server aimed at managing the electronic mail. The sender client is adapted to be connected to destination servers that manage the e-mail services of the destination clients to which the concerned electronic message to be transmitted is addressed. The electronic messages to be transmitted via e-mail often have electronic documents or files annexed thereto, also known as attachments.

A rapid diffusion of the e-mail is to be expected, also extended to cellular radiotelephones operating according to the GPRS, UMTS and I-MODE communication standards, as well as to the hand held computers or PDA (Personal Digital Assistant), possibly provided with communication devices.

However, the e-mail applications have certain drawbacks.

First of all, a very extended disuniformity exists among operative systems, software man-machine interfaces of the various client computers (computer, PDA, radiotelephone) as well as among many software applications used to generate and visualise the attachments. This entails that each e-mail program is substantially different from the others both in respect of its aspect and of its functions, thereby requiring an adaptation of the operator to the functions of his client. Additionally, the destination client can also be unable to correctly look-up a file attached to a message from a sender client, because it is lacking of the related programs.

Furthermore, when a user has to attach only a portion of a file, it is necessary to extract such portion from the original file, to save it in a memory, location accessible under a new name and generate the message. Besides that, upon generating a message, it is no more possible to make changes to the attached file: it will be necessary to generate a new message. Similar problems arise when it is desired to forward a portion of a just received attachment to another destination client. All above operations can be considered as an extremely cumbersome procedure which additionally requires that the program by which the original attachment was generated to be available on the sender client, thereby precluding these activities for a client, such as PDA, lacking of high computation capability.

These difficulties are to be overcome for fulfilling the needs of the information communication systems of the near future: the share of possibly dynamic data (texts, images, music, video) and the ease management, delivery and reception of the same data.

All up to new proposed approaches have not been found effective.

For instance, the company Microsoft® has suggested the OLE (Object Embedding and Linking) that allows objects to be exchanged between different programs. Anyway, the OLE System has some limitations and drawback: it was developed only in connection with Microsoft® programs and its complexity makes all concerned programs easier and consequently unapplicable to clients having a restricted computation capability, such as PDA, as well as amenable to virus infection.

The problem of diffusion of informatic virus and the problem of protection in respect of not authorised accesses are extremely important, in view of the fact that many companies desire their employees to cooperate in working on certain electronic documents by sharing them.

A further problem raised by presently available e-mail programs is the need of continuous and expensive, in terms of time and money, software up-date operations.

Aiming at enabling attached files of different types to be looked-up, the user ought to provide their addressee or destination client with even and even more numerous and complex information programs, with the users typically exploiting less than 10% of their capabilities, thereby making the situation worse, in terms of system heaviness and instability.

A further aspect to be considered in the field of management of personal information and communication is the constantly increasing number of web pages on Internet network, which makes even more difficult to locate the desired data in reasonable times. The ever increasing server power, together with the increase in the communication network speed have indirectly caused an excessive increase of the information amount to the detriment of the access rapidity: when a client frequently accesses the same web page, this causes noticeable wait times, that are not justifiable if the user in only interested in a very small portion of the web page.

It will be apparent that, upon finding the required information, a means would be useful to enable only the information portion of interest to be retrieved and easily shared with other users without further burdening the communication network. The presently adopted approaches are not satisfactory: sending a link to the whole page obliges the destination client to download the whole web page; retrieving the desired information, saving and dispatching it as attachment which causes a loss in the dynamic up-dates of the original web page.

Besides Microsoft®, other companies have proposed some solutions of the above mentioned problems and drawbacks, but no one of said solutions has been found to be fully effective.

A further proposed solution is the Push technology, according to which the servers have to send a continuous flow of up-dates to the interested clients, but, as it is apparent to those skilled in the art, the extremely large data amount involved in the communications causes huge problems.

A further solution related to the web sites is connected with universal portals, according to which each web site ought to be implemented and up-dated in several different electronic formats in order to enable a client having a different computing capability to be connected under maintainment of a homogeneous interface. This solution is extremely expensive and requires continuously repeated adjustments.

Similarly, other companies, such as Eudora Web®, Snippets®, Octopus®, Onepage®, Yodlee®, Quickbrowse, DoDots®, Websanity®, Pumatech®, 3 Com®, IPM-Net®, Efax®, Thoughtshare®, Infabuild® have proposed solutions having some drawbacks: unloading of whole web pages; incompleteness of files to be looked-up; need of specific programs; unavailability of a large computing capability on clients; excessive complexity of the utilised programs; long times needed for connection to the network; program unstability; use of dedicated expensive and cumbersome electronic devices or hardware.

The solution proposed by this invention is to be considered in this context.

It is an object of this invention, therefore, to provide a method for composing and transmitting as well as a method for looking-up an electronic message, including one or more attached files, which unable a simple and flexible interaction between a user and a client, by providing for electronic documents visualizable by means of informatic programs to be visualised on the display of the client even if such programs are not embodied in the computer, because, for instance, it is provided with a computing capability that is not sufficient to perform them.

It is further object of this invention to reduce the connection and data transfer times in accessing the communication networks.

It is still a further object of this invention to provide the instruments needed in performing the methods and apparatus to perform the methods.

It is specific subject-matter of this invention a method for composing and transmitting electronic messages, including one or more files attached thereto, from a sender client, provided with a display, to one or more destination clients, said sender client being adapted to connect to a corresponding electronic mail management sender server, each destination client being adapted to connect to a corresponding electronic mail management destination server, said electronic mail management sender server being adapted to send electronic messages to each electronic mail management destination server, said composing and transmitting method being characterized in that it comprises the following steps:

A. visualizing a first graphic interface on the display of the sender client, for attaching the file to an electronic message;

B. in response to a first action carried out on said first graphic interface, starting the attachment operation;

C. in response to further actions carried out on said first graphic interface and/or on the display of the sender client, selecting an object to be attached, said object to be attached being

at least a portion having an initial point and a final point of a file having an initial portion and a final portion, as visualized on the display of the sender client, or

a file accessible from the sender client, a reference of which is visualized on the display of said sender client, or

a portion of the display of the sender client, said portion having an initial point and a final point,

D. in response to a second action carried out on said first graphic interface, selecting an attachment type, said attachment type being

a graphic image of the object to be attached, or

a link to the object to be attached,

E. in response to a final action carried out on said first graphic interface, visualizing a second graphic interface on the display of said sender client, for inserting the addresses of the destination clients and for confirming the dispatch of the electronic message,

F. dispatching a specific electronic message to each electronic mail management destination server and including for each attachment an attached file comprising:

when the selected attachment type is a graphic image, a graphic image of the object to be attached,

when the selected attachment type is a link and the object to be attached is stored in a memory location that is freely accessible from a destination client corresponding to the destination server, a link to said memory location and data aimed at identifying the object to be attached,

when the selected attachment type is a link and the object to be attached is stored in a memory location that is not freely accessible from one or more destination clients corresponding to the destination server.

a) when the object to be attached comprises one or more links to files stored in memory locations that are not freely accessible from at least a destination client corresponding to the destination server or it comprises one or more links to files not attached to the electronic message, a graphic image of the object to be attached, otherwise

b) the object to be attached in the electronic format in which it was generated,

said steps B, C and D being repeated for each file to be attached.

In this specification and in the annexed claims, the term “memory location freely accessible from a computer” indicates an internal memory location of the computer which accesses it or a memory location external to the computer which the computer can access to visualize the contents, the access to the external location being not controlled and/or protected for instance by a system of key words or passwords.

Also according to this invention, said step C can comprise the following sub-step:

C1. in response to a third action carried out on said display, selecting a first point of the display.

Again according to this invention, said third action can consist in pressing at least once at least one push-button and/or generating a sound corresponding to overpositioning a graphic pointer on said first point of said display.

Further according to this invention, said third action can comprise pressing a bush-button of a pointer device.

The term “pointer device” as used in this specification and in the annexed claims indicates any electromechanical pointer means adapted to transmit to a computer provided with a display the signals for controlling the position and/or the displacement of a graphic pointer movable on said display as well as one or more selection signals. Among the pointer devices the following can be mentioned by way of exemplification the combination of an electronic tablet and of movable element adapted to electronically interact with said tablet; the combination of a sensitive screen and of an electronic pen; the rotating ball mouse, simply designated as “mouse”; the infrared mouse or so-called tailless mouse; the optical mouse; the trackpoint; the touchpad; the trackball; the foot-controlled mouse; the upper wheel mouse or Intellimouse.

According to this invention, said selected first point of the display can be a point of a visualized file and in that the object to be attached can be a portion of the visualized file having its initial point coincident with the initial portion of the visualized file and its final point coincident with the final portion of said visualized file.

Also according to this invention, said third action can comprise pressing twice a push-button of a pointer device.

Further according to this invention, said first selected point of the display can be a point corresponding to a reference, visualized on the display of said sender client, to a file accessible from said sender client and in that the object to be attached can be the file accessible from said sender client.

Preferably according to this invention, said reference visualized on the display of said sender client can be a link to or an alphanumeric code identifying a memory location in which said file, such as the path of the memory file system where such location is situated or an image of the file embodied within a container file is stored.

According to this invention, said step C can further comprise the following sub-step:

C2. in response to a fourth action carried out on said display, selecting a second point on said display.

Further according to this invention, said fourth action can comprise pressing at least once at least one push-button and/or generating a sound corresponding to overpositioning, a graphic pointer on said second point of said display.

Further according to this invention, said fourth action can comprise pressing a bush-button of a pointer device.

According to this invention, said first selected point on the display and said second selected point on the display can be points of a same visualized file and in that the object to be attached can be a portion of said visualized file having its initial point coincident with the first selected point on the display and its final point coincident with said second selected point on the display.

Still according to this invention, said first selected point on the display and said second selected point on the display can be points of different files visualized on the display of the sender client and in that the object to be attached can be a portion of the display having its initial point coincident with said first selected point on the display and its final point coincident with said second selected point on the display, said step B being adapted to select, as attachment type, only the graphic image.

Further according to this invention, said step D can be adapted to select, as attachment type, also the electronic format in which the object to be attached has been generated, said step F including, in the specific electronic message sent to each destination server, for each attachment whose selected attachment type is the electronic format in which the object to be attached has been generated, an attached file comprising:

c) when the object to be attached includes one or more links to files stored in memory locations not freely accessible from at least one destination client corresponding to the destination server or it includes one or more links to files not attached to the electronic message, a graphic image of the object to be attached, otherwise

d) the object to be attached in the electronic format in which it has been generated.

Again according to this invention, said step C can comprise the following sub-step:

C3. in response to a fifth action carried out on said first graphic interface, deleting at least one of the preceding, actions carried out on said first graphic interface and/or on the display of the sender client.

Still according to this invention, said step C can comprise the following sub-step:

C4. in response to a sixth action carried out on said first graphic interface, visualizing a third graphic interface comprising the lists of the objects and of the types of the preceding attachments.

Further according to this invention, the final action carried out on said first graphic interface can be a consecutive repetition of the second action carried out on said first graphic interface in step D.

Still according to this invention, said second graphic interface can comprise one or more sections for inserting the addresses of the destination clients, each section including a list of stored homogeneous alphanumeric addresses.

Further according to this invention, should the list of at least one section be not empty, said step E can comprise the following sub-step:

E1. in response to a seventh action carried out on a first area of said second graphic interface corresponding to a stored address, entering said stored address among the addresses of the destination clients.

According to this invention, should the list of at least one section be not empty, said step E can comprise the following sub-step:

E2. in response to an eighth action carried out on a second area of said second graphic interface corresponding to a stored address, entering a text to be attached to the electronic message dispatched to the destination client corresponding to said stored address.

Yet according to this invention, said sub-step E2 carried out in response to said eighth action can comprise visualizing a fourth graphic interface for insertion of a text.

Further according to this invention, said step E can comprise the following sub-step:

E3. in response to a ninth action carried out on said second graphic interface, inserting a text to be attached to the electronic message.

Still according to this invention, said sub-step E3 carried out in response to said ninth action can comprise visualizing a fifth graphic interface for insertion of a text.

Again according to this invention, said second graphic interface can comprise:

a first section including, as addresses, a list of memory locations accessible from the sender client and/or

a second section including, as addresses, a list of electronic mail addresses and/or

a third section including, as addresses, a list of telephone numbers and/or alphanumeric codes that identify telephone numbers.

Further according to this invention, said step E can comprise the following sub-step:

E4. in response to a tenth action carried out on said second graphic interface, visualizing a sixth graphic interface for confirming the dispatch of said electronic message.

Still according to this invention, performance of said step F can be conditioned on performance of an eleventh action on the same graphic interface.

Still according to this invention, said step E can comprise the following sub-step:

E5. in response to said eleventh action, selecting an operation type on said electronic message, the operation type including an immediate dispatch, by performing said step F, or a delayed dispatch and/or a storage,

should the selected operation type be a delayed dispatch, the method indicates the electronic message at the successive connection of the sender client to the electronic mail management sender server.

Further according to this invention, said actions carried out on said graphic interfaces can comprise pressing at least one push-button and/or generating a sound.

Still according to this invention, at least one of said graphic interfaces can include at least one graphic element corresponding to an action that can be carried put on said interface itself and in that said action that can be carried out can include pressing the push-button of a pointer device in a position corresponding to the superposition of a graphic pointer to the corresponding graphic element.

Preferably according to this invention, said at least one graphic element can comprise a graphic push-button and/or a selectable graphic box.

Still according to this invention, said first graphic interface can comprise a graphic push-button for each selectable attachment type.

Still according to this invention, said sixth graphic interface can comprise a graphic push-button for each selectable attachment type.

It is further specific subject-matter of this invention a method for receiving and looking-up an electronic message, including one or more files attached thereto, by a destination client, provided with a display, said electronic message being dispatched by a sender client adapted to connect to a corresponding electronic mail management sender server, said destination client being adapted to connect to a corresponding electronic mail management destination server, said electronic mail management sender server being adapted to dispatch electronic messages to said electronic mail management destination server, said receiving and looking-up method being characterized in that it comprises the following steps:

G. checking the graphic visualization capabilities of the destination client,

H. signalling the arrival of the electronic message to said destination client,

I. visualizing on the display of said destination client a seventh visualization graphic interface including the address of the sender client and the list of the files attached to the electronic message,

J. in response to selection actions carried out on said seventh graphic interface, selecting an operation type in respect of at least one of the selected files, said operation type being selected among visualizing a graphic image of the attached file and/or visualizing the attached file in a textual electronic format and/or visualizing the attached file in the electronic format in which it was generated and/or down-loading the attached file into a memory location accessible for the destination client and/or composing a new electronic message including at least a portion of the attached file,

K. in response to a twelfth action carried out on said seventh graphic interface and for each attached file in respect of which an operation type has been selected,

when the selected operation type is the selection of a graphic image, visualizing a graphic image of the attached file on the display of the destination client, by performing at least one computer program stored in the destination server and/or stored in the destination client,

when the selected operation type is the visualization in a textual electronic format, visualizing the attached file in a textual electronic format on the display of the destination client, by performing at least one computer program stored in the destination server and/or stored in the destination client,

when the selected operation type is the visualization in the electronic format in which the attached file was generated, visualizing the attached file in the electronic format in which it was generated on the display of the destination client, by performing at least one computer program stored in the destination server and/or stored in the destination client,

when the selected operation type is a down-load, down-loading the attached file from the destination server to a memory location accessible to said destination server,

when the selected operation type is the composition of a new electronic message, composing a new electronic message and attaching at least a portion of the attached file thereto.

According to this invention, when the selected operation type in step J is a visualization type, said step K can be conditioned on a check of the graphic visualization capabilities of the destination client cited in step G.

Still according to this invention, when the selected operation type in step J is a visualization type in respect of which the graphic visualization capabilities of the destination client are not sufficient, said step J can comprise the following sub-step:

J1. indicating that the graphic visualization capabilities of the destination client are not sufficient.

Further according to this invention, said step K can perform, in response to the twelfth action and when the selected operation type is the composition of a new message, the method for composing and transmitting electronic messages as above described.

Still according to this invention, said step K can also include, in response to the twelfth action and when the selected operation type is a down-load, visualizing the attached file on the display of the destination client in the format in which it was generated, by performing at least one computer program stored in the destination server and/or stored in the destination client.

Still according to this invention, at least one of the attached files can include textual information and said step J can be adapted to also select, as operation type, a vocal reproduction of said textual information, said step k including, in response to said twelfth action and when the selected operation type is the vocal reproduction, the vocal reproduction of the textual information of the attached file, by performing at least one computer program stored in the destination server and/or stored in the destination client.

Further according to this invention, said actions carried out on said seventh graphic interface can comprise pressing at least once at least one push-button and/or generating a sound.

Still according to this invention, said seventh graphic interface can include at least one graphic element corresponding to an action performable on said same interface and in that said performable action comprises pressing a push-button of a pointer device in a position corresponding to the overposition of a graphic pointer onto the corresponding graphic element.

Preferably according to this invention, said at least one graphic element can comprise a graphic push-button and/or a selectable graphic box.

Still according to this invention, said seventh graphic interface can comprise a graphic push-button for each selectable operation type.

Still according to this invention, the received electronic message can be composed and transmitted by means of the method for composing and transmitting electronic messages as above described.

Still according to this invention, when at least one of the files attached to the electronic message is a link to a memory location freely accessible from the destination client, the method can further comprise the following step:

L. periodically checking the contents of the object to be attached and, each time a change is detected in said contents, signalling said change in the contents to the destination client.

Further according to this invention, the sender client and/or the destination clients are computers and/or PDA and/or cellular radiotelephones and/or fax devices.

It is further subject-matter of this invention, a sender client adapted to connect to a corresponding electronic mail management sender server, characterized in that it is adapted to carry out said step A, said step B, said step C, said step D and said step E of the method for composing and transmitting electronic messages as above described.

It is still further subject-matter of this invention a computer program characterized in that it includes code means adapted to carry out, when they operate on a sender client, said step A, said step B, said step C, said step D and said step E of the method for composing and transmitting electronic messages as above described.

It is further subject-matter of this invention a computer readable memory medium having a program stored therein, characterized in that said program is a computer program as above described.

It is further subject-matter of this invention an electronic mail management sender server adapted to connect to a corresponding sender client, characterized in that it is adapted to carry out said step F of the method for composing and transmitting electronic messages as above described.

It is further subject-matter of this invention a computer program characterized in that it includes code means adapted to carry out, when they operate on an electronic mail management sender client, said step F of the method for composing and transmitting electronic messages as above described.

It is further subject-matter of this invention a computer readable memory medium having a program stored therein, characterized in that said program is a computer program as above described.

It is further subject-matter of this invention a destination client adapted to connect an electronic mail management destination server, characterized in that it is adapted to carry out said step I, said step J and said step K of the method for receiving and looking-up an electronic message as above described.

It is further subject-matter of this invention a computer program characterized in that it includes code means adapted to carry out, when they operate on a destination client, said step I, said step J and said step K of the method for receiving and looking-up an electronic message as above described.

It is further subject-matter of this invention a computer readable memory medium having a program stored therein, characterized in that said program is a computer program as above described.

It is further subject-matter of this invention an electronic mail management destination server adapted to connect to a corresponding destination client, characterized in that it is adapted to carry out said step G, said step H and said step K of the method for receiving and looking-up an electronic message as above described.

According to this invention, the destination server can be adapted to also carry out said step L of the method for receiving and looking-up an electronic message as above described.

It is further subject-matter of this invention a computer program characterized in that it includes code means adapted to carry out, when they operate on an electronic mail management destination server, said step G, said step H and said step K of the method for receiving and looking-up an electronic message as above described.

According to this invention, said computer program can also include further code means adapted to carry out said step L of the method for receiving and looking-up an electronic message as above described.

It is further subject-matter of this invention a computer readable memory medium having a program stored therein, characterized in that said program is a computer program as above described.

This invention will be now described by way of explanation not by way of limitation, in its preferred embodiments, by particularly referring to the attached drawings, in which:

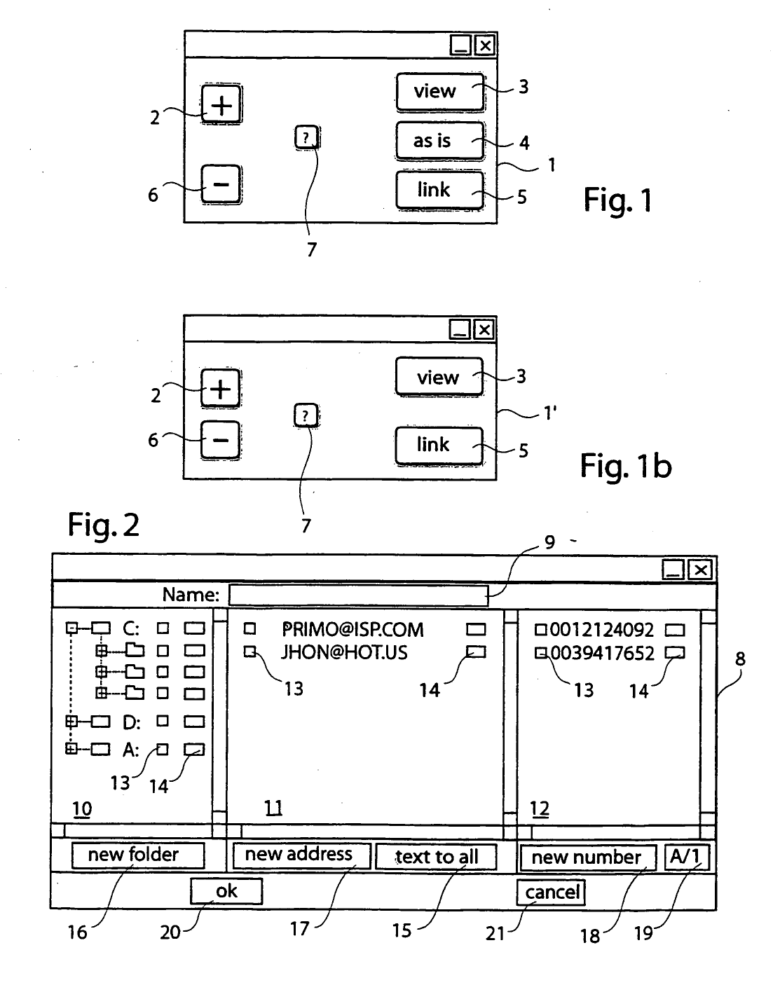

FIG. 1 shows a preferred embodiment of the first graphic interface for use in the method for composing and transmitting electronic messages according to this invention;

FIG. 2 shows a preferred embodiment of the second graphic interface for use in the method for composing and transmitting electronic messages according to this invention;

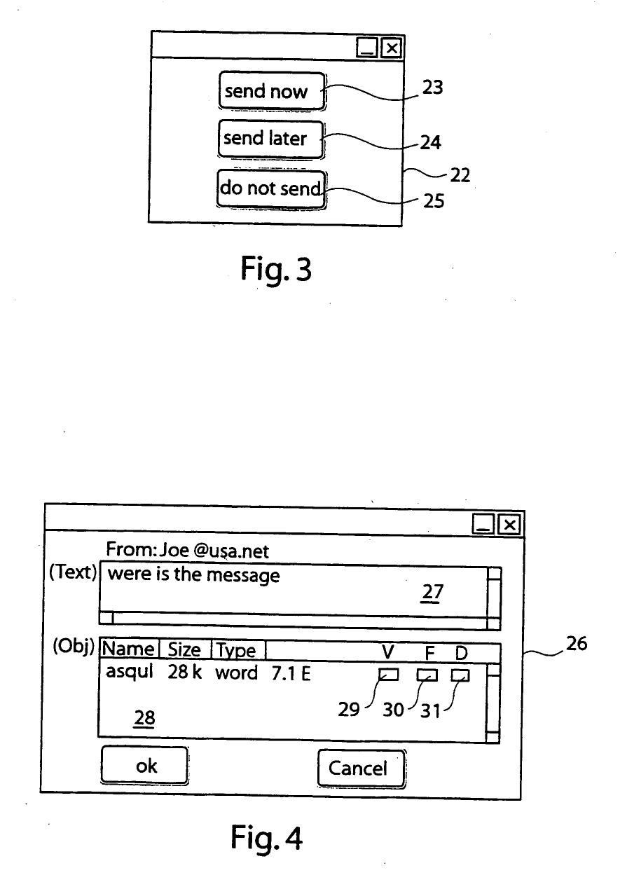

FIG. 3 shows a preferred embodiment of the sixth graphic interface for use in the method for composing and transmitting electronic messages according to this invention;

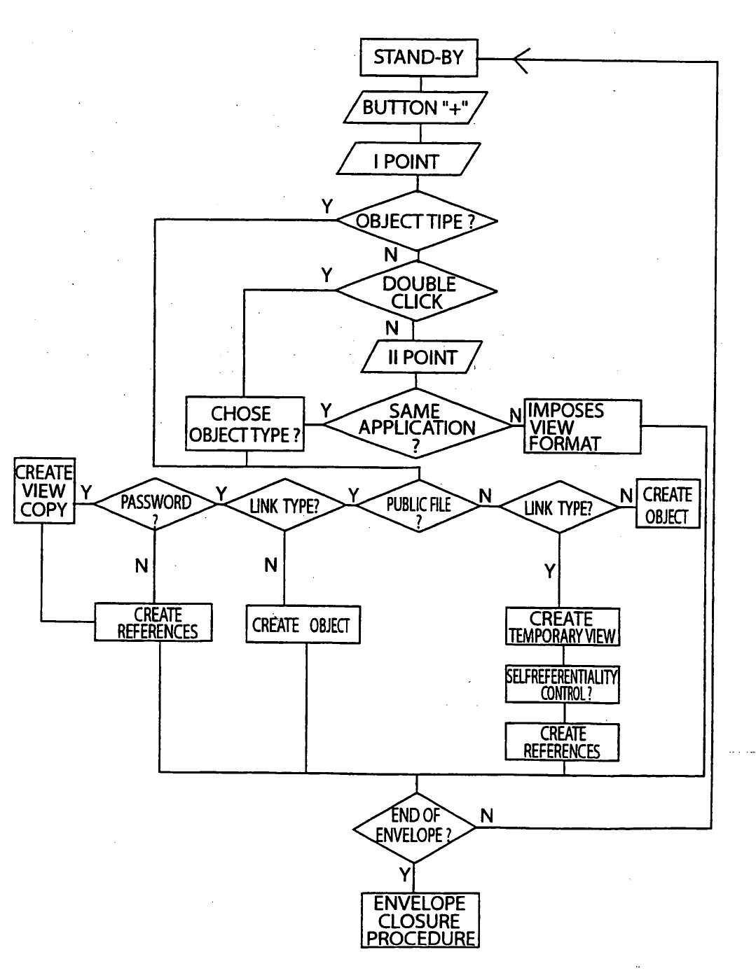

FIG. 4 shows a preferred embodiment of the seventh graphic interface for use in the method for receiving and looking-up an electronic message according to this invention; and

FIG. 5 shows a flow chart to schematically illustrate the preferred embodiment of the method for composing and transmitting electronic messages according to the invention.

In the following description, the same reference numerals will be used to designate the same items in the Figures.

In developing the invention, the inventor has closely considered some essential characteristics of informatic and electronic systems: mobility, rapidity in trasferring and accessing data; intrinsic limitations in some computer typologies, such as PDA, which are due, for instance, to poor graphic resolution; endurance of the batteries; specific data input devices, such as scarcely handy virtual keyboards on display.

According to the solution proposed by this invention, the larger portion of the computing power is embodied in the servers dedicated to mail, or anyway in servers strictly connected therewith, which will carry out not only the distribution functions, but also the data conversion functions, that are essential to overcome the various incompatibility situations. A very light program enables the client to compose the messages to be transmitted and/or to visualize the received attached objects, since it can modify and forward them to other destination subjects. The electronic mail servers (among which the so-called “proxy” servers connected thereto are considered as included in this description and in the claims) incorporate a more complex program, adapted to recognise the instrumentation of the client connected thereto and to accordingly modify the file type sent to the client.

Accordingly to a preferred embodiment of this invention, the sender client generates and handles the objects to be attached. Such objects, in turn, are files, but this, however, is completely transparent to the user. What is seen by the user is a simple interface, a single window with which the user can dialogue, whichever is the application program from which he desires to retrieve a portion of a file or a file as a whole.

These objects are selected and defined in simple and direct way, by only utilizing a mouse or a pen (on PDA), and are attached to the message which is being composed. The message is allotted a name, destination addresses and a comment text.

The sender client is provided with a composition program which starts on switching on the computer and is invoked, for instance, by clicking on an icon located in the pan.

By referring to FIG. 1, the first graphic interface 1, preferably a window, can be observed therein. The user has only to indicate, for instance by operating a mouse, the regious to be sent, as follows:

moving in the application containing the first object to be attached;

clicking on the graphic push-button 2, indicating the start of a new attachment operation;

clicking on the first point of the new object;

freely moving in the document up to reaching the region of the last point;

clicking on the last point; and

clicking on one of the three graphic push-buttons designated in Figure with reference numerals 3, 4 and 5, in order to select the attachment type.

If an other object is to be attached, it is sufficient to move thereto and to click again on the graphic push-button 2, thereby repeating the procedure.

When, however, the procedure is completed and no further objects are to be attached, it will be sufficient to click again on graphic push-button 3, 4 or 5, as just selected.

Said graphic push-buttons 3, 4 and 5, by which the attachment type can be selected, are extremely powerful. In fact, an object can be an area visualised by an application program, or a whole file, or a portion of the display, or a whole image or even a link on the web. In particular:

by clicking on graphic push-button 3 (view), the object is attached as a graphic image; or, in other words a photograph of the selected image is attached;

by clicking on graphic push-button 4 (As Is), the object is attached in the original electronic format; or, in other words, the selected file or the selected portion of the concerned file as presently contained is attached, upon saving it in the format of the application by which the concerned file has been generated and/or open;

by clicking on graphic push-button 4 (Link), a link to the object is attached and the content of the memory location which such link refers to dynamically changes when the object changes, so that any changement made in a file attached as a link before transmitting the message affects the transmitted message.

Should an error be made, then graphic push-button 6 is aimed at taking a backward step, while graphic push-button 7 opens a window to show the already attached objects and the operation stage reached at that time. In particular, said graphic push-button 6 can enable only the last operation to cancelled or, more preferably, the backward succession of all previously carried out operations.

By referring to FIG. 1b, it can be observed that, according to a different embodiment of this invention, a simplified version of the first graphic interface 1′ is characterised in that said graphic push-button 4 is omitted and, therefore, an object cannot be attached in the original electronic format.

When an attachment procedure is completed, a second graphic interface, preferably a window is open, in order to enable the names and the addresses of the destination addressees to be selected. These destination addressees can be memory locations included within or accessible to the sender client, destination clients connected together with the sender client to a local area network or LAN (such as the ones established within companies), e-mail addresses, UMTS cellular radiotelephones or fax numbers.

FIG. 2 shows the preferred embodiment of the second graphic interface, designated by reference numeral 8.

The name of the message is inserted into the upper area 9.

The central portion of the window includes three sections 10, 11 and 12 evidencing a list of addresses each having laterally associated a selectable graphic box 13, all graphic boxes 13 being contemporaneously selectable.

The first section 10 includes a list of memory locations internal or accessible to the sender client; preferably, it is a map of the storage systems of the sender client.

The second section 11 includes a list of e-mail addresses, both LAN and external addresses, also including possibly the address of the same sender client.

The third section 12 includes telephone numbers, preferably associated to cellular radiotelephones, as well as fax numbers.

As concerns each section, it is possible to insert for each selection made a brief customised comment text, by clicking on a graphic push-button 14 located beside each item. In detail:

if the text is inserted into the first section 10, it is a comment to the stored message;

if it is inserted into the second section 11, it is displayed by the destination client, just as it presently occurs for a standard e-mail message;

if the text is inserted into the third section 12 in corresponding position to the number of a cellular radiotelephone, than the text is transmitted as a SMS;

if the text is inserted into the third section 12 in corresponding position to a fax number, then it would be pointed in the head section of a fax message.

It is also possible to generate a single unique text for all destination addresses, by clicking the graphic push-button 15.

A corresponding graphic push-button 16. 17 and 18 is provided under each one of the three sections 10, 11 and 12, respectively aimed at enabling a new document, a new e-mail address and a new telephone number, respectively, to be generated and/or stored in conventional way.

A further graphic push-button 19 is provided under the third section 12: when it is clicked on, the concerned telephone numbers are substituted by the personal names which they correspond to.

Lastly, an “OK” graphic push-button 20 and a “Cancel” graphic push-button 21 are provided. By clicking on graphic push-button 20, the fist graphic interface 1 or 1′ is again displayed, while by clicking on graphic push-button 21, a last graphic interface 22 shown in FIG. 3 is displayed. Preferably, this last graphic interface 22 is open only when a destination addressee in second or in third section 11 or 12 is selected.

In particular, the last graphic interface 22 includes three graphic push-buttons 23, 24 and 25 each of which corresponds to one operation type to be carried out on the just composed message:

by clicking on the first graphic push-button 23, the message is immediately sent;

by clicking on the second graphic push-button 24, the message will be sent at the next connection from the sender client to the sender server and, in this case, an indication will be furnished to inform that messages exist waiting for being sent;

by clicking on the third graphic push-button 25, the message is temporaneously stored and no indication will be furnished about its existence as generated by a next connection from the sender client to the sender server.

By referring now to FIG. 4, graphic interface 26 can be observed, preferably a window, which is open at reception of a message and includes:

an upper area, in which the address of the sender client is visualised;

a first section 27, in which the eventual text associated to a message is displayed;

A second section 28, in which the list of the files attached to the message is displayed.

In detail, three selectable graphic boxes 29, 30 and 31 are provided beside each attached file, respectively corresponding to complete visualisation (V or View) to fast visualisation (F or Fastview) and to down-load of the file (D or Download). Other options can be easily integrated, such as the audio vocal generation of the textual contents or the translation into another language.

FIG. 5 shows a flow chart of the preferred embodiment of the method for composing and transmitting electronic messages according to the invention that, based upon the above set forth explanations, appears to be immediately readable by those skilled in the art.

For further comprehension of this invention, some application examples of the preferred embodiment will be described hereinbelow, similar examples being applicable to other embodiments.

It is assumed that a user generates and sends an electronic message including a portion of a file created by means of a videowriting program, for instance Winword®, form a sender client to a destination client, in the original electronic format. The concerned message is transferred from the sender server to the destination server, which indicates the arrival of the message upon the display of the destination client. Assuming that he is travelling, the destination user receives the indication, for instance a SMS message, on the destination telephone/PDA, which is not equipped with a videowriting program (in this instance Winword®). The destination user is connected to the destination server, that sends the list of the files attached to the electronic message to the display of the destination client. The destination user can select the sole portion of the Winword® file so as to request the destination server to provide for its visualisation as a graphic image. The destination server launches the Winword® program and the consequent graphic conversion application (a macro could also be sufficient). The destination server is aware that the destination client is a PDA provided with a certain operation system and with a certain graphic resolution and, therefore, it conforms the display to the capabilities of the destination client: for instance, should it ascertain that the graphic resolution of the destination client is poor, it could send only the text of the document, without any formattation.

In this way, the destination user is enabled to see what has been sent to him, even if his client is not equipped with the necessary application. Furthermore, the destination user can print the first two pages of the Winword® file portion of the message by utilising a fax and can generate by the PDA a new electronic message including the original format (Winword®) or as image. In fact, the method for generating electronic messages is recursive, in the sense that it is possible to generate electronic messages including objects that point (dynamically or not) to objects included in other electronic messages. The destination user completes the new electronic message and issues a command to dispatch it: the request does not include the image to be sent, but only the request that identifies the data in the original electronic message, then it retrieves and inserts such data into a new electronic message: all this operation is performed in the destination server, with resulting noticeable reduction of the connection time. The destination user dispatches the new electronic message to the fax number as called by the destination server. The fax message is received in printed format just as it were seen under Winword®. The file in Winword® format as included in the initial electronic message is anyway resident in the destination server and it can be down-loaded by the destination user through a different intermediary client.

This invention can be advantageously applied to Internet for looking-up and sharing web pages.

At present, when it is desired to repeatedly look-up a specific web page of a site, for instance a page including the graph of a stock or the latest news, it is necessary to access the web site, to down-load the whole page (comprising business advertisements, moving images, “cookies”) and to move the mouse or the pointer to the display area of interest. When the access is performed from a PDA computer, it is possible to navigate only among sites specifically designated for PDA.

This invention enables instead a user to connect a first time to the desired page, to speedily create an electronic message including, in Link format (and, therefore, in dynamic format) the object it is desired to look-up (image, text portion or like) and to send it to his electronic mail address: each time the concerned user (who is at the same time both sender and addressee) looks-up this electronic message from any destination client, the destination server read the web page, retrieves the portion of interest therefrom and sends only this retrieved portion of interest to the destination client in the graphic format available to the specific destination client. It is apparent that the connection times are extremely reduced.

In addition to the high data transfer speed, which is due to the fact that lower data amounts are transferred to and from sender and destination servers, a further advantage achieved by this invention is that the diffusion of informatic viruses is dramatically reduced. In fact, the files in many cases are never locally transferred to the clients, but preferably they are resident in the servers and consequently the clients are not amenable to viruses. Besides that, even if a destination user decides to locally down-load a file, the anti-virus programs embedded in the servers are able to carry out more powerful and accurate checks.

A further advantage, which is more evident in the case of LAN networks at company level, is the possibility to integrate mail servers with proxy servers, so as to guarantee a high safety and speed to the users. In fact, when the sender client and the destination client are both connected in the same LAN, the shared portions of the web pages, preferably periodically up-dated, would be in many cases already present in the company's proxy servers when the electronic message is opened, thereby further reducing the connection time to the destination client.

Should the sender user wish to attach a whole file, already opened and visualised by means of his application program, it will sufficient to click one only time on the window of his application program and to select the attachment type without clicking on a second point.

Should the sender users be utilising a navigation program or browser, each image and each link can be selected by a double click action thereupon, followed by selection of the attachment type.

In particular, when the concerned browser displays the file list on a file system, it is possible to attach a whole file by clicking twice on the associated reference (name, path, alphanumeric code) and then select the attachment type.

When an object already attached as a link (and, therefore, a dynamic one) is a file locally stored in the sender client, and it is not shared, the electronic message maintains its format (link) only up to the sending instant, since the destination client cannot access the original file and, as a consequence, it will necessarily receive the concerned file in one of the other two possible formats. This conversion is carried out on sending the electronic message which the file is attached to. On the contrary, when the dynamic link is oriented to a public file (for instance, a shared file in a company LAN or a web page), such change in format is not necessary, unless the file is protected by a password.

The preferred embodiments of this invention have been described and a number of variations have been suggested hereinbefore, but it should expressly be understood that those skilled in the art can make other variations and changes, without so departing from the scope thereof, as defined by the annexed claims.

1.- A method for composing and transmitting electronic messages, including one or more files attached thereto, from a sender client, provided with a display, to one or more destination clients, said sender client being adapted to connect to a corresponding electronic mail management sender server, each destination client being adapted to connect to a corresponding electronic mail management destination server, said electronic mail management sender server being adapted to send electronic messages to each electronic mail management destination server, said composing and transmitting method being characterized in that it comprises the following steps:
A. visualizing a first graphic interface (1; 1′) on the display of the sender client, for attaching the file to an electronic message;
B. in response to a first action carried out on said first graphic interface (1; 1′), starting the attachment operation;
C. in response to further actions carried out on said first graphic interface (1; 1′) and/or on the display of the sender client, selecting an object to be attached, said object to be attached being
at least a portion having an initial point and a final point of a file having an initial portion and a final portion, as visualized on the display of the sender client, or
a file accessible from the sender client, a reference of which is visualized on the display of said sender client, or
a portion of the display of the sender client, said portion having an initial point-and a final point,
D. in response to a second action carried out on said first graphic interface (1; 1′), selecting an attachment type, said attachment type being
a graphic image of the object to be attached, or
a link to the object to be attached,
E. in response to a final action carried out on said first graphic interface (1; 1′), visualizing a second graphic interface (8) on the display of said sender client, for inserting the addresses of the destination clients and for confirming the dispatch of the electronic message,
F. dispatching a specific electronic message to each electronic mail management destination server and including for each attachment an attached file comprising:
when the selected attachment type is a graphic image, a graphic image of the object to be attached,
when the selected attachment type is a link and the object to be attached is stored in a memory location that is freely accessible from a destination client corresponding to the destination server, a link to said memory location and data aimed at identifying the object to be attached,
when the selected attachment type is a link and the object to be attached is stored in a memory location that is not freely accessible from one or more destination clients corresponding to the destination server:
a) when the object to be attached comprises one or more links to files stored in memory locations that are not freely accessible from at least a destination client corresponding to the destination server or it comprises one or more links to files not attached to the electronic message, a graphic image of the object to be attached, otherwise
b) the object to be attached in the electronic format in which it was generated,
said steps B, C and D being repeated for each file to be attached.

2.- A method according to claim 1, characterized in that said step C comprises the following sub-step:
C1. in response to a third action carried out on said display, selecting a first point of the display.

3.- A method according to claim 2, characterized in that said third action consists in pressing at least once at least one push-button and/or generating a sound corresponding to overpositioning a graphic pointer on said first point of said display.

4.- A method according to claim 3, characterized in that said third action comprises pressing a bush-button of a pointer device.

5.- A method according to any one of claims 2 to 4, characterized in that said selected first point of the display is a point of a visualized file and in that the object to be attached is a portion of the visualized file having its initial point coincident with the initial portion of the visualized file and its final point coincident with the final portion of said visualized file.

6.- A method according to claim 3, characterized in that said third action comprises pressing twice a push-button of a pointer device.

7.- A method according to claim 6, characterized in that said first selected point of the display is a point corresponding to a reference, visualized on the display of said sender client, to a file accessible from said sender client and in that the object to be attached is the file accessible from said sender client.

8.- A method according to claim 7, characterized in that said reference visualized on the display of said sender client is a link to or an alphanumeric code identifying a memory location in which said file or an image of the file embodied within a container file is stored.

9.- A method according to any one of claims 2 to 4, characterized in that said step C further comprises the following sub-step:
C2. in response to a fourth action carried out on said display, selecting a second point on said display.

10.- A method according to claim 9, characterized in that said fourth action comprises pressing at least once at least one push-button and/or generating a sound corresponding to overpositioning a graphic pointer on said second point of said display.

11.- A method according to claim 10, characterized in that said fourth action comprises pressing a bush-button of a pointer device.

12.- A method according to any one of claims 9 to 11, characterized in that said first selected point on the display and said second selected point on the display are points of a same visualized file and in that the object to be attached is a portion of said visualized file having its initial point coincident with the first selected point on the display and its final point coincident with said second selected point on the display.

13.- A method according to any one of claims 9 to 11, characterized in that said first selected point on the display and said second selected point on the display are points of different files visualized on the display of the sender client and in that the object to be attached is a portion of the display having its initial point coincident with said first selected point on the display and its final point coincident with said second selected point on the display, said step B being adapted to select, as attachment type, only the graphic image.

14.- A method according to any one of claims 1 to 12, characterized in that said step D is adapted to select, as attachment type, also the electronic format in which the object to be attached has been generated, said step F including, in the specific electronic message sent to each destination server, for each attachment whose selected attachment type is the electronic format in which the object to be attached has been generated an attached file comprising:
c) when the object to be attached includes one or more links to files stored in memory locations not freely accessible from at least one destination client corresponding to the destination server or it includes one or more links to files not attached to the electronic message, a graphic image of the object to be attached, otherwise
d) the object to be attached in the electronic format in which it has been generated.

15.- A method according to any one of the preceding claims, characterized in that said step C comprises the following sub-step:
C3. in response to a fifth action carried out on said first graphic interface (1; 1′), deleting at least one of the preceding actions carried out on said first graphic interface (1; 1′) and/or on the display of the sender client.

16.- A method according to any one of the preceding claims, characterized in that said step C comprises the following sub-step:
C4. in response to a sixth action carried out on said first graphic interface (1; 1′), visualizing a third graphic interface comprising the lists of the objects and of the types of the preceding attachments.

17.- A method according to any one of the preceding claims, characterized in that the final action carried out on said first graphic interface (1; 1′) is a consecutive repetition of the second action carried out on said first graphic interface (1; 1′) in step D.

18.- A method according to any one of the preceding claims, characterized in that said second graphic interface (8) comprises one or more sections (10; 11; 12) for inserting the addresses of the destination clients, each section (10; 11, 12) including a list of stored homogeneous alphanumeric addresses.

19.- A method according to claim 18, characterized in that, should the list of at least one section (10; 11; 12) be not empty, said step E comprises the following sub-step:
E1. in response to a seventh action carried out on a first area (13) of said second graphic interface (8) corresponding to a stored address, entering said stored address among the addresses of the destination clients.

20.- A method according to claim 18 or 19, characterized in that, should the list of at least one section (10; 11; 12) be not empty, said step E comprises the following sub-step:
E2. in response to an eighth action carried out on a second area (14) of said second graphic interface (8) corresponding to a stored address, entering a text to be attached to the electronic message dispatched to the destination client corresponding to said stored address.

21.- A method according to claim 20, characterized in that said sub-step E2 carried out in response to said eighth action comprises visualizing a fourth graphic interface for insertion of a text.

22.- A method according to any one of claims 18 to 21, characterized in that said step E comprises the following sub-step:
E3. in response to a ninth action carried out on said second graphic interface (8), inserting a text to be attached to the electronic message.

23.- A method according to claim 22, characterized in that said sub-step E3 carried out in response to said ninth action comprises visualizing a fifth graphic interface for insertion of a text.

24.- A method according to any one of claims 18 to 23, characterized in that said second graphic interface (8) comprises:
a first section (10) including, as addresses, a list of memory locations accessible from the sender client and/or
a second section (11) including, as addresses, a list of electronic mail addresses and/or
a third section (12) including, as addresses, a list of telephone numbers and/or alphanumeric codes that identify telephone numbers.

25.- A method according to any one of claims 18 to 24, characterized in that said step E comprises the following sub-step:
E4. in response to a tenth action carried out on said second graphic interface (8), visualizing a sixth graphic interface (22) for confirming the dispatch of said electronic message.

26.- A method according to claim 25, characterized in that performance of said step F is conditioned on performance of an eleventh action on the same graphic interface (22).

27.- A method according to claim 26, characterized in that said step E comprises the following sub-step:
E5. in response-to said eleventh action, selecting an operation type on said electronic message, the operation type including an immediate dispatch, by performing said step F, or a delayed dispatch and/or a storage,
should the selected operation type be a delayed dispatch, the method indicates the electronic message at the successive connection of the sender client to the electronic mail management sender server.

28.- A method according to any one of the preceding claims, characterized in that said actions carried out on said graphic interfaces comprise pressing at least one push-button and/or generating a sound.

29.- A method according to claim 28, characterized in that at least one of said graphic interfaces includes at least one graphic element (2; 3; 4; 5; 6; 7; 13; 14; 15; 16; 17; 18; 19; 20; 21; 23; 24; 25) corresponding to an action that can be carried put on said interface itself and in that said action that can be carried out includes pressing the push-button of a pointer device in a position corresponding to the superposition of a graphic pointer to the corresponding graphic element.

30.- A method according to claim 29, characterized in that said at least one graphic element comprises a graphic push-button and/or a selectable graphic box.

31.- A method according to claim 30, characterized in that said first graphic interface (1; 1′) comprises a graphic push-button (3; 4; 5) for each selectable attachment type.

32.- A method according to claims 27 and 30, characterized in that said sixth graphic interface (22) comprises a graphic push-button (23; 24; 25) for each selectable attachment type.

33.- A method according to any one of the preceding claims, characterized in that said sender client and/or said destination clients are computers and/or PDA and/or cellular radiotelephones and7or fax devices.

34.- A method for receiving and looking-up an electronic message, including one or more files attached thereto, by a destination client, provided with a display, said electronic message being dispatched by a sender client adapted to connect to a corresponding electronic mail management sender server, said destination client being adapted to connect to a corresponding electronic mail management destination server, said electronic mail management sender server being adapted to dispatch electronic messages to said electronic mail management destination server, said receiving and looking-up method being characterized in that it comprises the following steps:
G. checking the graphic visualization capabilities of the destination client,
H. signalling the arrival of the electronic message to said destination client,
I. visualizing on the display of said destination client a seventh visualization graphic interface (26) including the address of the sender client and the list of the files attached to the electronic message,
J. in response to selection actions carried out on said seventh graphic interface (26), selecting an operation type in respect of at least one of the selected files, said operation type being selected among visualizing a graphic image of the attached file and/or visualizing the attached file in a textual electronic format and/or visualizing the attached file in the electronic format in which it was generated and/or down-loading the attached file into a memory location accessible for the destination client and/or composing a new electronic message including at least a portion of the attached file,
K. in response to a twelfth action carried out on said seventh graphic interface (26) and for each attached file in respect of which an operation type has been selected,
when the selected operation type is the selection of a graphic image, visualizing a graphic image of the attached file on the display of the destination client, by performing at least one computer program stored in the destination server and/or stored in the destination client,
when the selected operation type is the visualization in a textual electronic format, visualizing the attached file in a textual electronic format on the display of the destination client, by performing at least one computer program stored in the destination server and/or stored in the destination client,
when the selected operation type is the visualization in the electronic format in which the attached file was generated, visualizing the attached file in the electronic format in which it was generated on the display of the destination client, by performing at least one computer program stored in the destination server and/or stored in the destination client,
when the selected operation type is a down-load, down-loading the attached file from the destination server to a memory location accessible to said destination server,
when the selected operation type is the composition of a new electronic message, composing a new electronic message and attaching at least a portion of the attached file thereto.

35.- A method according to claim 34, characterized in that, when the selected operation type in step J is a visualization type, said step K is conditioned on a check of the graphic visualization capabilities of the destination client cited in step G.

36.- A method according to claim 35, characterized in that, when the selected operation type in step J is a visualization type in respect of which the graphic visualization capabilities of the destination client are not sufficient, said step J comprises the following sub-step:
J1. indicating that the graphic visualization capabilities of the destination client are not sufficient.

37.- A method according to any one of claims 34 to 36, characterized in that said step K performs, in response to the twelfth action and when the selected operation type is the composition of a new message, the method for composing and transmitting electronic messages according to any one of claims 1 to 33.

38.- A method according to any one of claims 34 to 37, characterized in that said step K also includes, in response to the twelfth action and when the selected operation type is a down-load, visualizing the attached file on the display of the destination client in the format in which it was generated, by performing at least one computer program stored in the destination server and/or stored in the destination client.

39.- A method according to any one of claims 34 to 38, characterized in that at least one of the attached files includes textual information and in that said step J is adapted to also select, as operation type, a vocal reproduction of said textual information, said step k including, in response to said twelfth action and when the selected operation type is the vocal reproduction, the vocal reproduction of the textual information of the attached file, by performing at least one computer program stored in the destination server and/or stored in the destination client.

40.- A method according to any one of claims 34 to 38, characterized in that said actions carried out on said seventh graphic interface (26) comprise pressing at least once at least one push-button and/or generating a sound.

41.- A method according to claim 40, characterized in that said seventh graphic interface (26) includes at least one graphic element (29; 30; 31) corresponding to an action performable on said same interface and in that said performable action comprises pressing a push-button of a pointer device in a position corresponding to the overposition of a graphic pointer onto the corresponding graphic element.

42.- A method according to claim 41, characterized in that said at least one graphic element comprises a graphic push-button and/or a selectable graphic box (29; 30, 31).

43.- A method according to claim 42, characterized in that said seventh graphic interface (26) comprises a graphic push-button for each selectable operation type.

44.- A method according to any one of the preceding claims, characterized in that the sender client and/or the destination client are computers and/or PDA and /or cellular radiotelephones and/or fax devices.

45.- A method according to any one of claims 34 to 44, characterized in that the received electronic message is composed and transmitted by means of the method for composing and transmitting electronic messages according to any one of claims 1 to 33.

46.- A method according to claim 45, characterized in that, when at least one of the files attached to the electronic message is a link to a memory location freely accessible from the destination client, the method further comprises the following step:
L. periodically checking the contents of the object to be attached and, each time a change is detected in said contents, signalling said change in the contents to the destination client.

47.- A sender client adapted to connect to a corresponding electronic mail management sender server, characterized in that it is adapted to carry out said step A, said step B, said step C, said step D and said step E of the method for composing and transmitting electronic messages according to any one of claims 1 to 33.

48.- A computer program characterized in that it includes code means adapted to carry out, when they operate on a sender client, said step A, said step B, said step C, said step D and said step E of the method for composing and transmitting electronic messages according to any one of claims 1 to 33.

49.- A computer readable memory medium having a program stored therein, characterized in that said program is a computer program according to claim 48.

50.- An electronic mail management sender server adapted to connect to a corresponding sender client, characterized in that it is adapted to carry out said step F of the method for composing and transmitting electronic messages according to any one of claims 1 to 33.

51.- A computer program characterized in that it includes code means adapted to carry out, when they operate on an electronic mail management sender client, said step F of the method for composing and transmitting electronic messages according to any one of claims 1 to 33.

52.- A computer readable memory medium having a program stored therein, characterized in that said program is a computer program according to claim 51.

53.- A destination client adapted to connect an electronic mail management destination server, characterized in that it is adapted to carry out said step 1, said step J and said step K of the method for receiving and looking-up an electronic message according to any one of claims 34 to 46.

54.- A computer program characterized in that it includes code means adapted to carry out, when they operate on a destination client, said step 1, said step J and said step K of the method for receiving and looking-up an electronic message according to any one of claims 34 to 46.

55.- A computer readable memory medium having a program stored therein, characterized in that said program is a computer program according to claim 54.

56.- An electronic mail management destination server adapted to connect to a corresponding destination client, characterized in that it is adapted to carry out said step G, said step H and said step K of the method for receiving and looking-up an electronic message according to any one of claims 34 to 46.

57.- A destination server according to claim 56, characterized in that it is adapted to also carry out said step L of the method for receiving and looking-up an electronic message according to claim 46.

58.- A computer program characterized in that it includes code means adapted to carry out, when they operate on an electronic mail management destination server, said step G, said step H and said step K of the method for receiving and looking-up an electronic message according to any one of claims 34 to 46.

59.- A computer program according to claim 58, characterized in that it also includes further code means adapted to carry out said step L of the method for receiving and looking-up an electronic message according to claims 46.

60.- A computer readable memory medium having a program stored therein, characterized in that said program is a computer program according to claim 58 or 59.
